(19) United States
(12) Patent Application Publication
(10) Pub. No.: US 2025/0110765 A1
(43) Pub. Date: Apr. 3, 2025

(54) IDENTIFYING DATA LAKE OWNERSHIP USING WRITE ACCESS LOGS

(71) Applicant: Intuit Inc., Mountain View, CA (US)

(72) Inventors: Saikiran Sri THUNUGUNTLA, Bangalore (IN); Sirsha CHATTERJEE, Ghaziabad (IN); Sreenivasulu NALLAPATI, Bangalore (IN); Vijaykumar HIREMATH, Bangalore (IN)

(73) Assignee: Intuit Inc., Mountain View, CA (US)

(21) Appl. No.: 18/375,364

(22) Filed: Sep. 29, 2023

(51) Int. Cl. G06F 9/455

(52) U.S. Cl. CPC G06F 9/45558; G06F 2009/45562; G06F 2009/4557; G06F 2009/45595

(57) ABSTRACT

Systems and methods for determining ownership of cloud computing resources are disclosed. An example method includes identifying a first active table whose ownership is not defined in a central repository, determining, based on a write log associated with the first active table, a first timestamp and a first internet address associated with a most recent write to the first active table, determining, based on the first internet address, whether or not the first timestamp is more recent than a creation time of a first cloud computing instance corresponding to the most recent write, and in response to the first timestamp being more recent than the creation time of the first cloud computing instance, identifying a first owner of the first active table based on a first cost allocation tag associated with the first cloud computing instance.

### TECHNICAL FIELD

This disclosure relates generally to determining ownership of cloud computing resources, and more particularly to determining ownership of data lake tables based on cloud computing access logs.

### DESCRIPTION OF RELATED ART

Cloud computing is increasingly common for data storage and software implementation. For example, such cloud computing resources may include data lakes, systems or repositories of data stored in its natural or raw format, such as using object blobs or files. Such data lakes may include structured data, such as various types of tables, for example SQL database tables, and so on. However, a single organization may include many teams, each operating on and managing a variety of cloud computing resources. It is important for such an organization to be able to know which team or individuals have ownership of such resources. However, cloud computing instances may be created or deleted frequently, making determination of ownership difficult, particularly at scale.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for determining ownership of cloud computing resources. An example method includes identifying a first active table whose ownership is not defined in a central repository, the first active table deployed as part of a first cloud computing instance, determining, based on a write log associated with the first active table, a first timestamp and a first internet address associated with a most recent write to the first active table, determining, based at least in part on the first internet address, whether or not the first timestamp is more recent than a creation time of the first cloud computing instance, and in response to the first timestamp being more recent than the creation time of the first cloud computing instance, identifying a first owner of the first active table based at least in part on a first allocation tab associated with the first cloud computing instance.

In some aspects, determining whether or not the first timestamp is more recent than the creation time of the first cloud computing instance includes determining a first cloud computing instance identifier associated with the first internet address, determining the creation time of the first cloud computing instance based at least in part on the first cloud computing instance identifier, and comparing the first timestamp to the creation time of the first cloud computing instance identified by the first cloud computing instance identifier.

In some aspects, the method further includes, in response to identifying the first owner, recording the first owner to the central repository as owner of the first active table.

In some aspects, the method further includes identifying a plurality of second active tables whose ownership is not defined in the central repository, each second active table deployed as part of a corresponding second cloud computing instance, and for each second active table of the plurality of second active tables: determining a third timestamp and a second internet address associated with a most recent write to the second active table, determining a second cloud computing instance identifier associated with the second internet address, comparing the third timestamp to a creation time of the second cloud computing instance identified by the second cloud computing instance identifier and in response to the third timestamp being more recent than the creation time of the second cloud computing instance, identifying a second owner of the second active table based at least in part on a cost allocation tag associated with the second cloud computing instance. In some aspects, the method further includes, for each identified second owner, recording the second owner to the central repository as owner of the corresponding second active table. In some aspects, identifying the plurality of second active tables whose ownership is not defined in the central repository includes periodically checking the central repository for active tables with undefined ownership, and in response to the periodic checking identifying a third active table having undefined ownership, adding the third active table to the plurality of second active tables. In some aspects, periodically checking the central repository includes periodically checking the central repository for tables which have been accessed or refreshed within a threshold period of time and for which no ownership is defined.

In some aspects, identifying the first owner of the first active table includes querying a developer repository based on the first cost allocation tag and identifying the first owner based on a response to the query.

In some aspects, the method further includes, in response to the creation time of the first cloud computing instance being more recent than the first timestamp, determining that the most recent write is not associated with the first cloud computing instance.

Another innovative aspect of the subject matter described in this disclosure can be implemented as a system for determining ownership of cloud computing resources. An example system includes one or more processors and a memory storing instructions for execution by the one or more processors. Execution of the instructions causes the system to perform operations including identifying a first active table whose ownership is not defined in a central repository, the first active table deployed as part of a first cloud computing instance, determining, based on a write log associated with the first active table, a first timestamp and a first internet address associated with a most recent write to the first active table, determining, based at least in part on the first internet address, whether or not the first timestamp is more recent than a creation time of the first cloud computing instance, and in response to the first timestamp being more recent than the creation time of the first cloud computing instance, identifying a first owner of the first active table based at least in part on a first allocation tab associated with the first cloud computing instance.

Another innovative aspect of the subject matter described in this disclosure can be implemented as a method for determining ownership of cloud computing resources. An example method includes identifying a first active table whose ownership is not defined in a central repository, the first active table deployed as part of a first cloud computing instance, determining, based on a write log associated with the first active table, a first timestamp and a first internet address associated with a most recent write to the first active table, determining a first cloud computing instance identifier associated with the first internet address, determining a creation time of the first cloud computing instance based at least in part on the first cloud computing instance identifier, comparing the first timestamp to the creation time of the first cloud computing instance identified by the first cloud computing instance identifier, in response to the first timestamp being more recent than the creation time of the first cloud computing instance, identifying a first cost allocation tag associated with the first cloud computing instance, and identifying a first owner of the first active table based at least in part on the first cost allocation tag.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a table ownership determination system, according to some implementations.

FIG. 2 shows a high-level overview of an example process flow that may be employed by the table ownership determination system of FIG. 1

FIG. 3 shows an illustrative flow chart depicting an example operation for determining ownership of cloud computing resources, according to some implementations.

FIG. 4 shows an illustrative flow chart depicting an example operation for determining ownership of cloud computing resources, according to some implementations. Like numbers reference like elements throughout the drawings and specification.

### DETAILED DESCRIPTION

The use of cloud computing resources is increasingly common, such that many companies and other organizations may deploy large numbers of cloud computing instances, such instances being created and deleted as needed. However, it becomes increasingly difficult for an organization to track ownership of deployed cloud resources, which may be important for tracking which individual or team is responsible for the maintenance, alteration, updating, and so on of the various cloud resources. Data lake tables may be one example type of such cloud computing resources for which ownership tracking may be important, such as to ensure regulatory compliance, safeguarding of personal information, security concerns, and so on. Data lakes may hold large amounts of data in its native, raw format. Such data may be included as tables within a data lake, and may be in any suitable format, such as an optimized row columnar (ORC) format, an Apache Parquet format, SQL, and so on. The contents of such data lake tables may be used in connection with a variety of applications, such as machine learning applications, accounting applications, business planning applications, statistical analysis applications, and a variety of other data-driven applications.

Some conventional techniques may identify and maintain ownership records for active data lake tables using dedicated repositories, such as Git repositories, for each table. Some other conventional techniques may employ computer engines or other configurable virtual machines to maintain ownership records for active data lake tables. However, such conventional techniques may be prohibitively computationally expensive for organizations employing large numbers of active data lake tables, or where new tables are frequently added and old tables deleted. It would therefore be desirable to identify ownership for active data lake tables in a more cost effective and computationally efficient manner.

Implementations of the subject matter described in this disclosure may be used to identify ownership for data lake tables deployed within an organization based on access records associated with the data lake tables. For example, ownership of a table may be inferred based on who is able to write to that table. More particularly, an address or other identifying information associated with a write to a table may identify hardware or cloud account information associated with a cloud instance which writes to the table. This cloud instance identifier may be used to ensure that the identified cloud instance was the instance which performed the write, that is, that the time of the write to the table occurred after creation of that cloud instance. Once verifying the cloud instance is the correct cloud instance, one or more cost allocation tags, or other billing tags associated with the cloud instance may be identified as corresponding to that cloud instance. These cost allocation tags are typically used for tracking costs associated with cloud deployments within an organization. Thus, an organization tracks which cost allocation tags are associated with the various individuals or teams within the organization. The cost allocation tags thus correspond to the individual or team who made the write to the data lake table. For example, an organization may provide an internal tool, such as a developer portal, an application programming interface (API), or another tool for determining the individual or team associated with the identified cost allocation tag. Thus, in accordance with the example implementations, information associated with a write to a data lake table, such as found in an access log, write log, event log, and so on, may be used to identify the individual or team which owns that table. These, and other aspects of the example implementations are discussed further below.

Various implementations of the subject matter disclosed herein provide one or more solutions to the technical problem of identifying data lake table ownership within organizations. As discussed above, conventional techniques, such as maintaining repositories for each active table, or using virtual machines such as compute engines to track ownership, may become prohibitively computationally expensive or may require significant expenditure of human resources. In contrast, the present implementations may infer ownership based on writes to an active data lake table, identify an address associated with the writes, such as an internet protocol (IP) address, determining a cloud instance associated with that address, verify that the cloud instance was created prior to the time of the writes, and identify the individual or group owning the table based on cost allocation tags associated with that cloud instance. More specifically, various aspects of the present disclosure provide a unique computing solution to a unique computing problem that did not exist prior to the widespread deployment of cloud computing resources for data storage and access. As such, implementations of the subject matter disclosed herein are not an abstract idea such as organizing human activity or a mental process that can be performed in the human mind-indeed, the human mind is not capable of accessing cloud computing resources.

Moreover, various aspects of the present disclosure effect an improvement in the technical field of tracking and maintaining ownership records for data lake tables, as compared to conventional techniques.

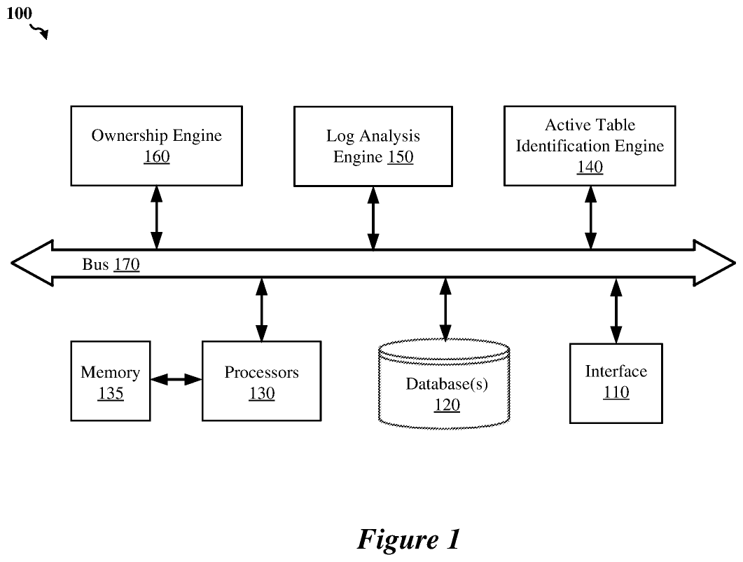

FIG. 1 shows a table ownership determination system 100, according to some implementations. The table ownership determination system 100 is shown to include an input/output (I/O) interface 110, a database 120, one or more data processors 130, a memory 135 coupled to the data processors 130, an active table identification engine 140, a log analysis engine 150, and an ownership engine 160. In some implementations, the various components of the table ownership determination system 100 may be interconnected by at least a data bus 170, as depicted in the example of FIG. 1. In other implementations, the various components of the table ownership determination system 100 may be interconnected using other suitable signal routing resources.

The interface 110 may include a screen, an input device, and other suitable elements that allow a user to provide information to the table ownership determination system 100 and/or to retrieve information from the table ownership determination system 100. Example information that can be provided to the table ownership determination system 100 may include configuration information for the table ownership determination system 100, configuration data for the active table identification engine, log analysis engine 150, or ownership engine 160, and so on. Example information that can be retrieved from the table ownership determination system 100 may include updated ownership information for one or more active tables, and the like.

The database 120, which may represent any suitable number of databases, may store any suitable information pertaining to configuration information for the table ownership determination system 100, tables storing ownership information for one or more data lake tables, write logs for one or more data lake tables, information connecting cost allocation tags to individuals or groups within an organization, and the like. In some implementations, the database 120 may be a relational database capable of presenting the information as data sets to a user in tabular form and capable of manipulating the data sets using relational operators. In some aspects, the database 120 may use Structured Query Language (SQL) for querying and maintaining the database 120.

The data processors 130, which may be used for general data processing operations (such as manipulating the data stored in the database 120 or querying one or more databases within or coupled to the table ownership determination system 100), may be one or more suitable processors capable of executing scripts or instructions of one or more software programs stored in the table ownership determination system 100 (such as within the memory 135). The data processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 130 may be implemented as a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the data processors 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The active table identification engine 140 may identify data lake tables lacking ownership information. More particularly, the active table identification engine 140 may analyze records of recently accessed or refreshed data lake tables to identify the tables lacking ownership information. In some aspects, data identifying the data lake tables lacking ownership may be stored in one or more tables or databases, such as within the database 120. For example, the active table identification engine 140 may use the log analysis engine 150 to analyze logs of recorded accesses or refreshes of data lake tables to identify those lacking ownership information. Such information may then be used by the log analysis engine 150 and ownership engine 160 in order to identify the individual or groups owning the identified tables lacking ownership information.

The log analysis engine 150 may analyze logs, such as access logs, event lots, write logs, and so on, in order to identify a recent write to a table lacking ownership information, identify an address, such as an IP address, associated with the recent write, and verify that a cloud instance associated with the IP address was the cloud instance associated with the recent write. The cloud instance may be, for example, an Amazon Web Services (AWS) EC2 instance, a Microsoft Azure instance, a Google Cloud instance, or another cloud computing instance. As discussed in more detail below, verifying that the cloud instance is associated with the recent write may include determining a cloud instance identifier (ID) based on the address, and determining a time of creation, such as a timestamp, of the cloud instance associated with the cloud instance ID. The cloud instance associated with the IP address is the cloud instance associated with the recent write when the time of creation of the cloud instance precedes the time of the recent write.

The ownership engine 160 may determine ownership of data lake tables associated with a verified cloud instance IDs. That is, after the log analysis engine 150 determines that the cloud instance associated with the address of the recent write is actually the cloud instance responsible for that recent write, the ownership engine 160 identifies the individual or group associated with that cloud instance as the owner of the data lake table. As discussed in more detail below, the ownership engine 160 may determine a cost allocation tag, billing tag, or another identifier associated with the cloud instance, and identify the individual or group associated with that cost allocation tag as the owner of the data lake table.

The particular architecture of the table ownership determination system 100 shown in FIG. 1 is but one example of a variety of different architectures within which aspects of the present disclosure may be implemented. For example, in other implementations, the table ownership determination system 100 may not include the active table identification engine 140, the functions of which may be implemented by the processors 130 executing corresponding instructions or scripts stored in the memory 135. In some other implementations, the functions of the log analysis engine 150 may be performed by the processors 130 executing corresponding instructions or scripts stored in the memory 135. Similarly, the functions of the ownership engine 160 may be performed by the processors 130 executing corresponding instructions or scripts stored in the memory 135.

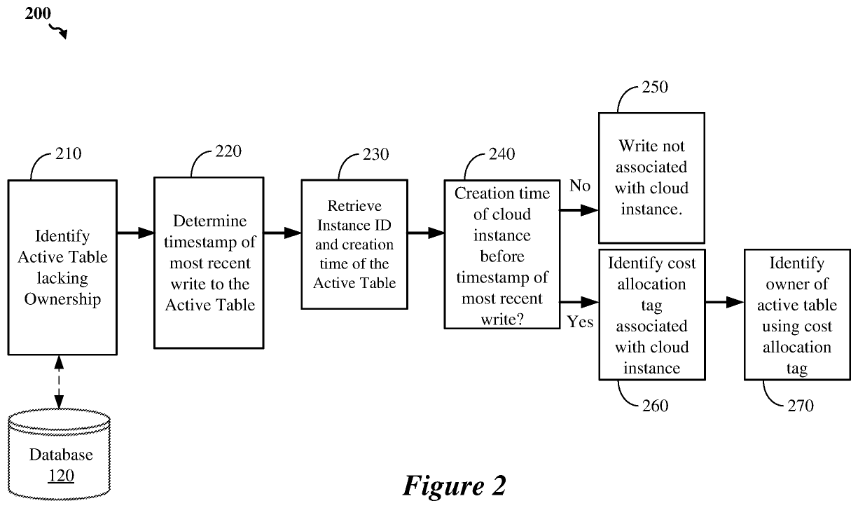

FIG. 2 shows a high-level overview of an example process flow 200 that may be employed by the table ownership determination system 100 of FIG. 1. In block 210, the table ownership determination system 100 identifies an active table lacking ownership, the active table deployed as part of a first cloud computing instance. For example, the active table may be identified by consulting the database 120 or by consulting another database listing tables and ownership information via one or more network interfaces coupled to the table ownership determination system 100. In block 220, the table ownership determination system 100 may determine a timestamp associated with a most recent write to the identified active table. For example, as discussed in more detail below, this timestamp may be determined by consulting an event log, write log, or other log listing accesses to the active table. In block 230, the table ownership determination system 100 may retrieve a cloud instance ID and a creation time associated with the cloud instance. For example, the instance ID and creation time may be determined based on an IP address associated with the most recent write in the event log. In block 240, the table ownership determination system 100 may determine whether the creation time of the cloud instance precedes the timestamp of the most recent write. If the most recent write has a timestamp before the creation time of the cloud instance, then in block 250, the table ownership determination system 100 may determine that the most recent write is not associated with the cloud instance. If the creation time of the cloud instance is before the timestamp of the most recent write, then in block 260, the table ownership determination system 100 may identify a cost allocation tag associated with the cloud instance. For example, such cost allocation tags may be added to all cloud instances within an organization upon provisioning. In block 270, the table ownership determination system 100 may identify the owner of the active table based on the cost allocation tag. For example, an organization may maintain records tying the cost allocation tags to individuals or groups within the organization, and the table ownership determination system 100 may consult these records, which may take the form of a developer API or another tool for identifying the individuals or groups associated with each cost allocation tag.

As discussed above, tracking ownership of cloud deployed data structures, such as data lake tables, may be increasingly difficult for large organizations, and conventional techniques for tracking such ownership do not scale well. For example, maintaining ownership records in repositories, such as Git repositories, for each cloud deployed data structure may not be feasible for such numerous deployed tables. Similarly, use of virtual machines, such as compute engines, for tracking ownership of each deployed data structure may be unreasonably resource intensive as well. The example implementations use write permissions as a proxy for ownership and combine this insight with analysis of the cloud instance associated with a deployed data structure and internal recordkeeping to identify ownership in a much more resource-efficient manner.

The example implementations may first identify one or more cloud deployed tables, such as one or more data lake tables, whose ownership is unknown. For example, an organization may maintain records, such as a central repository or database, indicating which individuals or groups within the organization have ownership of which cloud resources. As discussed above, such records are often incomplete, particularly with respect to ownership. One or more active tables may be identified from such records. In some aspects, such records may be consulted periodically to identify active tables lacking ownership, and the individual or group owning each identified active table may be determined using the example implementations. In some aspects, only tables which have been accessed or refreshed recently, such as within a threshold period of time, and lack ownership records may be identified by the example implementations.

After identifying an active table whose ownership is unknown, such as not being defined in records such as a central repository or database, an access or event log is consulted for that active table. The log may indicate recent access to the active table, and more particularly recent writes to the active table. For example, when the active table is deployed as part of an AWS instance, such a log may be a cloudtrail S3 access log or S3 server access log. Such logs may include information about recent events associated with the active table, such as a timestamp of a recent event, a type of event, such as read or write, and information about which account or instance address is associated with the event. For example, such information may be more specifically found in an S3 server access log. For example, the log entry for an event may indicate that it is a write event, occurring at a time specified by a timestamp, that the write event is associated with a specified cloud account, and with a particular IP address. In accordance with the example implementations, a recent, such as a most recent, write event to the active table is selected from the log, and a first timestamp associated with that write event is determined from the log, in addition to the IP address associated with that write event.

The IP address of the selected recent write event may correspond to a cloud instance ID, such as an AWS EC2 instance ID or an instance ID of another cloud provider. For example, the cloud provider may provide an API, such as an AWS API, and the cloud instance ID associated with the IP address may be determined by submitting a query using this cloud provider API. A variety of information may be determined about the cloud instance identified by the cloud instance ID, such as a creation time or timestamp. Because cloud instances are often transient, being created and deleted at will, it is important to verify that the cloud instance identified by the IP address is the same cloud instance which performed the selected write event. To verify the cloud instance is the cloud instance associated with the write event, the timestamp of the selected recent write event and the timestamp of the cloud instance's creation may be compared, to verify that the cloud instance was created prior to the timestamp of the recent write. If the write event occurred prior to the creation of the cloud instance, then ownership of the active table cannot be determined based on that cloud instance.

After verifying that the selected recent write event occurred after creation of the cloud instance associated with the IP of that write event, the ownership of the active table may be determined based on the attributes of that cloud instance. More particularly, each cloud instance may be associated with one or more cost allocation tags. For example, within the organization, on provisioning each cloud instance may be required to include one or more cost allocation tags. Such cost allocation tags may be used to track cloud computing costs across the organization, such as for determining how much each individual or group within the organization spends on cloud services. The example implementations may identify the individual or group owning the active table based on the cost allocation tags of with the cloud instance associated with the IP of the selected recent write event. For example, an organization may maintain internal records of which individual or group corresponds to each cost allocation tag. Such records may be accessible, for example, via querying a developer API or another tool. Thus, ownership of the active table may be determined as the individual or group corresponding to the cost allocation tags of the cloud instance associated with the IP address of the selected recent write event, provided that the cloud instance was created prior to the timestamp of that selected recent write event. The ownership records of the organization may then be updated to reflect this ownership.

If multiple active tables were identified as lacking ownership records, then ownership of each of these active tables may be determined as described above. Thus, by scanning for missing ownership records periodically, and performing the above-described techniques, an organization may maintain up to date ownership records for deployed data lake tables and do so more efficiently than using conventional techniques.

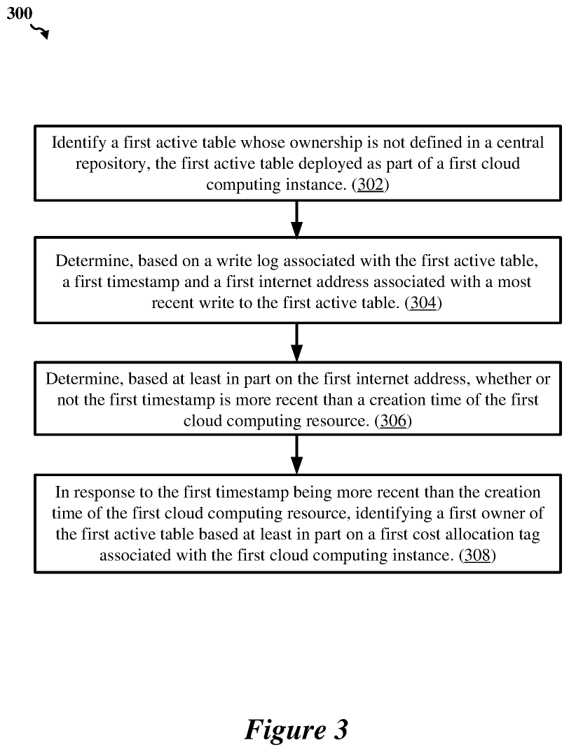

FIG. 3 shows an illustrative flow chart depicting an example operation 300 for determining ownership of cloud computing resources, according to some implementations. The example operation 300 may be performed by one or more processors of a computing device, and in some implementations, the example operation 300 may be performed using the table ownership determination system 100 of FIG. 1. It is to be understood that the example operation 300 may be performed by any suitable systems, computers, or servers.

At block 302, the table ownership determination system 100 identifies a first active table whose ownership is not defined in a central repository, where the first active table is deployed as part of a first cloud computing instance. At block 304, the table ownership determination system 100 determines, based on a write log associated with the first active table, a first timestamp and a first internet address associated with a most recent write to the first active table. At block 306, the table ownership determination system 100 determines, based at least in part on the first internet address, whether or not the first timestamp is more recent than a creation time of the first cloud computing instance. At block 308, the table ownership determination system 100, in response to the first timestamp being more recent than the creation time of the first cloud computing instance, identifies a first owner of the first active table based at least in part on a first cost allocation tag associated with the first cloud computing instance.

In some aspects, determining whether or not the first timestamp is more recent than the creation time of the first cloud computing instance in block 306 includes determining a first cloud computing instance identifier associated with the first internet address, determining the creation time of the first cloud computing instance based at least in part on the first cloud computing instance identifier, and comparing the first timestamp to the creation time of the first cloud computing instance identified by the first cloud computing instance identifier.

In some aspects, the operation 300 further includes, in response to identifying the first owner, recording the first owner to the central repository as owner of the first active table.

In some aspects, the operation 300 further includes identifying a plurality of second active tables whose ownership is not defined in the central repository, each second active table deployed as part of a corresponding second cloud computing instance, and for each second active table of the plurality of second active tables: determining a third timestamp and a second internet address associated with a most recent write to the second active table, determining a second cloud computing instance identifier associated with the second internet address, comparing the third timestamp to a creation time of the second cloud computing instance identified by the second cloud computing instance identifier and in response to the third timestamp being more recent than the creation time of the second cloud computing instance, identifying a second owner of the second active table based at least in part on a cost allocation tag associated with the second cloud computing instance. In some aspects, the operation 300 further includes, for each identified second owner, recording the second owner to the central repository as owner of the corresponding second active table. In some aspects, identifying the plurality of second active tables whose ownership is not defined in the central repository includes periodically checking the central repository for active tables with undefined ownership, and in response to the periodic checking identifying a third active table having undefined ownership, adding the third active table to the plurality of second active tables. In some aspects, periodically checking the central repository includes periodically checking the central repository for tables which have been accessed or refreshed within a threshold period of time and for which no ownership is defined.

In some aspects, identifying the first owner of the first active table in block 308 includes querying a developer repository based on the first cost allocation tag and identifying the first owner based on a response to the query.

In some aspects, the operation 300 further includes, in response to the creation time of the first cloud computing instance being more recent than the first timestamp, determining that the most recent write is not associated with the first cloud computing instance.

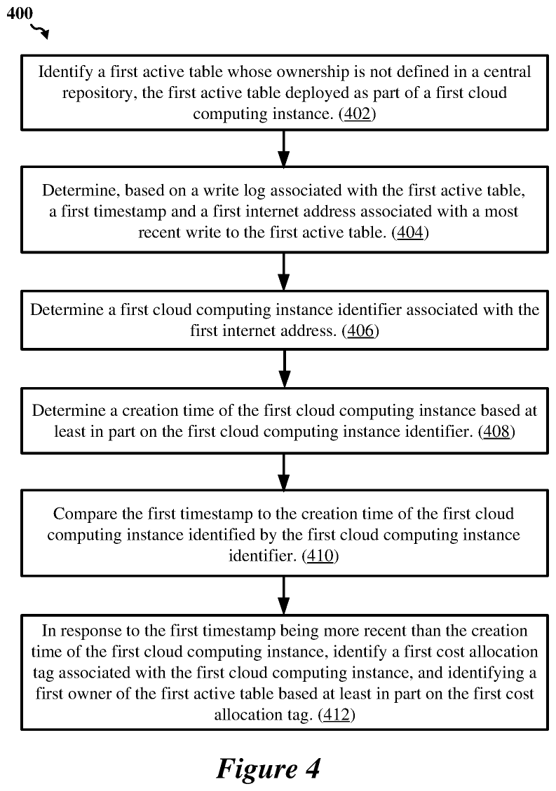

FIG. 4 shows an illustrative flow chart depicting an example operation 400 for determining ownership of cloud computing resources, according to some implementations. The example operation 400 may be performed by one or more processors of a computing device, and in some implementations, the example operation 400 may be performed using the table ownership determination system 100 of FIG. 1. It is to be understood that the example operation 400 may be performed by any suitable systems, computers, or servers.

At block 402, the table ownership determination system 100 identifies a first active table whose ownership is not defined in a central repository, the first active table deployed as part of a first cloud computing instance. At block 404, the table ownership determination system 100 determines, based on a write log associated with the first active table, a first timestamp and a first internet address associated with a most recent write to the first active table. At block 406, the table ownership determination system 100 determines a first cloud computing instance identifier associated with the first internet address. At block 408, the table ownership determination system 100 determines a creation time of the first cloud computing instance based at least in part on the first cloud computing instance identifier. At block 410, the table ownership determination system 100 compares the first timestamp to the creation time of the first cloud computing instance identified by the first cloud computing instance identifier. At block 412, the table ownership determination system 100, in response to the first timestamp being more recent than the creation time of the first cloud computing instance, identifies a first cost allocation tag associated with the first cloud computing instance, and identifies a first owner of the first active table based at least in part on the first cost allocation tag.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method for determining ownership of cloud computing resources, comprising:
identifying a first active table whose ownership is not defined in a central repository, the first active table deployed as part of a first cloud computing instance;
determining, based on a write log associated with the first active table, a first timestamp and a first internet address associated with a most recent write to the first active table;
determining, based at least in part on the first internet address, whether or not the first timestamp is more recent than a creation time of the first cloud computing instance; and
in response to the first timestamp being more recent than the creation time of the first cloud computing instance, identifying a first owner of the first active table based at least in part on a first cost allocation tag associated with the first cloud computing instance.

2. The method of claim 1, wherein determining whether or not the first timestamp is more recent than the creation time of the first cloud computing instance comprises:
determining a first cloud computing instance identifier associated with the first internet address;
determining the creation time of the first cloud computing instance based at least in part on the first cloud computing instance identifier; and
comparing the first timestamp to the creation time of the first cloud computing instance identified by the first cloud computing instance identifier.

3. The method of claim 1, further comprising, in response to identifying the first owner, adding the first owner to the central repository as owner of the first active table.

4. The method of claim 3, further comprising, identifying a plurality of second active tables whose ownership is not defined in the central repository, each second active table deployed as part of a corresponding second cloud computing instance, and for each second active table of the plurality of second active tables:
determining a third timestamp and a second internet address associated with a most recent write to the second active table;
determining a second cloud computing instance identifier associated with the second internet address;
comparing the third timestamp to a creation time of the second cloud computing instance identified by the second cloud computing instance identifier;
in response to the third timestamp being more recent than the creation time of the second cloud computing instance, identifying a second owner of the second active table based at least in part on a cost allocation tag associated with the second cloud computing instance

5. The method of claim 4, further comprising, for each identified second owner, adding the second owner to the central repository as owner of the corresponding second active table.

6. The method of claim 4, wherein identifying the plurality of second active tables whose ownership is not defined in the central repository comprises periodically checking the central repository for active tables with undefined ownership, and in response to the periodic checking identifying a third active table having undefined ownership, adding the third active table to the plurality of second active tables.

7. The method of claim 6, wherein periodically checking the central repository comprises periodically checking the central repository for tables which have been accessed or refreshed within a threshold period of time and for which no ownership is defined.

8. The method of claim 1, wherein the first active table is a data lake table.

9. The method of claim 1, wherein identifying the first owner of the first active table further comprises querying a developer repository based on the first cost allocation tag and identifying the first owner based on a response to the query.

10. The method of claim 1, further comprising, in response to the creation time of the first cloud computing instance being more recent than the first timestamp, determining that the most recent write is not associated with the first cloud computing instance.

11. A system for determining ownership of cloud computing resources, comprising:
one or more processors; and
a memory storing instructions that, when executed by the one or more processors, cause the system to perform operations comprising:
identifying a first active table whose ownership is not defined in a central repository, the first active table deployed as part of a first cloud computing instance;
determining, based on a write log associated with the first active table, a first timestamp and a first internet address associated with a most recent write to the first active table;
determining, based at least in part on the first internet address, whether or not the first timestamp is more recent than a creation time of the first cloud computing instance; and
in response to the first timestamp being more recent than the creation time of the first cloud computing instance, identifying a first owner of the first active table based at least in part on a first cost allocation tag associated with the first cloud computing instance.

12. The system of claim 11, wherein execution of the instructions for determining whether or not the first timestamp is more recent than the creation time of the first cloud computing instance causes the system to perform operations further comprising:
determining a first cloud computing instance identifier associated with the first internet address;
determining the creation time of the first cloud computing instance based at least in part on the first cloud computing instance identifier; and
comparing the first timestamp to the creation time of the first cloud computing instance identified by the first cloud computing instance identifier.

13. The system of claim 11, wherein execution of the instructions causes the system to perform operations further comprising, in response to identifying the first owner, adding the first owner to the central repository as owner of the first active table.

14. The system of claim 13, wherein execution of the instructions causes the system to perform operations further comprising, identifying a plurality of second active tables whose ownership is not defined in the central repository, each second active table deployed as part of a corresponding second cloud computing instance, and, for each second active table of the plurality of second active tables:
determining a third timestamp and a second internet address associated with a most recent write to the second active table;
determining a second cloud computing instance identifier associated with the second internet address;
comparing the third timestamp to a creation time of the second cloud computing instance identified by the second cloud computing instance identifier;
in response to the third timestamp being more recent than the creation time of the second cloud computing instance, identifying a second owner of the second active table based at least in part on a cost allocation tag associated with the second cloud computing instance

15. The system of claim 14, wherein execution of the instructions causes the system to perform operations further comprising, for each identified second owner, adding the second owner to the central repository as owner of the corresponding second active table.

16. The system of claim 14, wherein execution of the instructions for identifying the plurality of second active tables whose ownership is not defined in the central repository causes the system to perform operations further comprising periodically checking the central repository for active tables with undefined ownership, and in response to the periodic checking identifying a third active table having undefined ownership, adding the third active table to the plurality of second active tables.

17. The system of claim 16, wherein periodically checking the central repository comprises periodically checking the central repository for tables which have been accessed or refreshed within a threshold period of time and for which no ownership is defined.

18. The system of claim 11, wherein identifying the first owner of the first active table further comprises querying a developer repository based on the first cost allocation tag and identifying the first owner based on a response to the query.

19. The system of claim 11, wherein execution of the instructions causes the system to perform operations further comprising, in response to the creation time of the first cloud computing instance being more recent than the first timestamp, determining that the most recent write is not associated with the first cloud computing instance.

20. A method for determining ownership of cloud computing resources, comprising:
identifying a first active table whose ownership is not defined in a central repository, the first active table deployed as part of a first cloud computing instance;
determining, based on a write log associated with the first active table, a first timestamp and a first internet address associated with a most recent write to the first active table;
determining a first cloud computing instance identifier associated with the first internet address;
determining a creation time of the first cloud computing instance based at least in part on the first cloud computing instance identifier;
comparing the first timestamp to the creation time of the first cloud computing instance identified by the first cloud computing instance identifier;
in response to the first timestamp being more recent than the creation time of the first cloud computing instance, identifying a first cost allocation tag associated with the first cloud computing instance, and identifying a first owner of the first active table based at least in part on the first cost allocation tag.
